(19) United States
(12) Patent Application Publication
(10) Pub. No.: US 2025/0043932 A1
(43) Pub. Date: Feb. 6, 2025

(54) LIGHTING CIRCUIT

(71) Applicant: TOYO DENSO KABUSHIKI KAISHA, TOKYO (JP)

(72) Inventors: Kenjiro NASU, Saitama (JP); Madoka TAKAHASHI, Saitama (JP)

(73) Assignee: TOYO DENSO KABUSHIKI KAISHA, TOKYO (JP)

(21) Appl. No.: 18/765,520

(22) Filed: Jul. 8, 2024

(30) Foreign Application Priority Data
Aug. 3, 2023 (JP) 2023-127366

(51) Int. Cl. F21S 41/663; F21V 23/04; F21Y 115/10

(52) U.S. Cl. CPC F21S 41/663; F21V 23/0464; F21Y 2115/10

(57) ABSTRACT

A lighting circuit of the present disclosure includes a first light source and a second light source that light up to illuminate the same illuminated part. Both the first light source and the second light source are turned on in a preset first lighting situation, and the first light source is turned on and the second light source is turned off in a preset second lighting situation.

### INCORPORATION BY REFERENCE

This application is based upon and claims the benefit of priority from Japanese patent application No. 2023-127366, filed on Aug. 3, 2023, the disclosure of which is incorporated herein in its entirety by reference.

### TECHNICAL FIELD

The present disclosure relates to a lighting circuit.

### BACKGROUND ART

A vehicle is equipped with various indicator lights that indicate the state of the vehicle and the usage state of a device. At this time, the indication state of the indicator light, particularly luminance (brightness) is controlled to change for daytime use and nighttime use. For example, during the daytime when the surroundings are bright, the indicator light is controlled to be illuminated at higher luminance than during the nighttime so that the illumination of the indicator light is easily recognized. For example, Patent Literature 1 describes a technique of controlling the luminance of a single light source such as an LED (light-emitting diode) by providing a dimming circuit and controlling an electric current flowing during the daytime and the nighttime.
Patent Literature 1: Japanese Patent Publication No. 2807847

However, according to the technique described in Patent Literature 1 described above, the luminance is controlled by the amount of the electric current flowing through the single light source, and there is a limit to the controllable range, which causes a problem that it is difficult to make an extreme difference in luminance between daytime and nighttime. Therefore, the visibility of an illuminated part that is illuminated both during the daytime and during the nighttime cannot be increased.

### SUMMARY OF THE INVENTION

An object of the present disclosure is to solve the problem that the visibility of an illuminated part that is illuminated during the daytime and during the nighttime cannot be increased.

A lighting circuit as an aspect of the present disclosure includes a first light source and a second light source that light up to illuminate a same illuminated part. Both the first light source and the second light source are turned on in a preset first lighting situation, and the first light source is turned on and the second light source is turned off in a preset second lighting situation.

Further, a lighting device as an aspect of the present disclosure includes: a lighting circuit including a first light source and a second light source that light up to illuminate a same illuminated part; and the illuminated part. The lighting circuit is configured to turn on both the first light source and the second light source in a preset first lighting situation, and turn on the first light source and turn off the second light source in a preset second lighting situation.

Further, a lighting method as an aspect of the present disclosure is a lighting method by a lighting circuit including a first light source and a second light source that light up to illuminate a same illuminated part. The lighting method includes turning on both the first light source and the second light source in a preset first lighting situation, and turning on the first light source and turning off the second light source in a preset second lighting situation.

With the configurations as described above, the present disclosure can increase the visibility of an illuminated part that is illuminated during the daytime and during the nighttime.

### BRIEF DESCRIPTION OF DRAWINGS

FIG. 1 is a block diagram showing the overview of the configuration of an illumination device according to the present disclosure;

FIG. 2 is a view showing the configuration of an illumination circuit according to the present disclosure;

FIG. 3 is a view showing the configuration of the illumination circuit according to the present disclosure; and

FIG. 4 is a view showing the configuration of the illumination circuit according to the present disclosure.

### EXAMPLE EMBODIMENTS

### First Example Embodiment

The present disclosure will be described with reference to the drawings.

An illumination device according to this example embodiment illuminates an indicator light T (an illuminated part) installed in a vehicle. For example, the indicator light T indicates the state of the vehicle or the usage state of the device, and is provided on equipment in the vehicle, such as an instrument panel. Then, the illumination device is configured so that the luminance (brightness) of the indicator light T varies between daytime and nighttime. As will be described later, the daytime (a first lighting situation) refers to a situation in which the brightness inside the vehicle is determined to be bright according to a preset criterion, and the nighttime (a second lighting situation) refers to a situation in which the brightness inside the vehicle is determined to be dark according to a preset criterion.

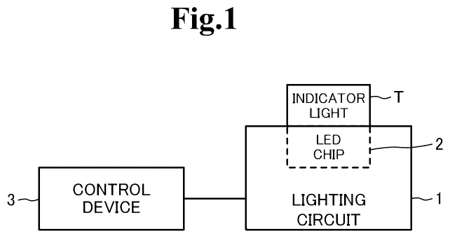

Specifically, as shown in FIG. 1, the illumination device includes the indicator light T, a lighting circuit 1 that illuminates the indicator light, and a control device 3 that controls the state of illumination by the lighting circuit 1. Then, the lighting circuit 1 is provided with an LED chip 2 serving as a light source that lights up so as to illuminate the indicator light T.

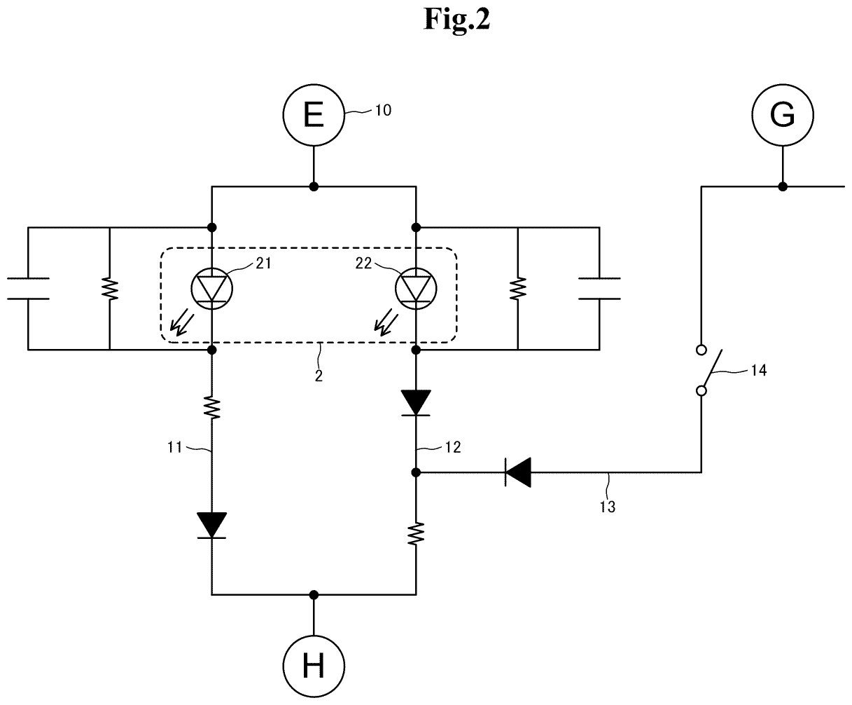

FIG. 2 shows an example of a specific circuit configuration of the lighting circuit 1. The LED chip 2 provided on the lighting circuit 1 includes two LEDs 21 and 22, both of which are configured with light-emitting diodes that emit light when an electric current flows therethrough. That is to say, the two LEDs 21 and 22 are integrated in the single LED chip 2 and arranged in close proximity to each other. Then, since the single LED chip 2 is provided corresponding to the one indicator light T, the two LEDs 21 and 22 are configured to illuminate the same indicator light T, respectively. At this time, in the case of illuminating a single indicator light with two LEDs, problems may arise such as uneven brightness due to an illumination range shifting by the distance between the two LEDs, and the device itself becoming larger in size due to the distance between the two LEDs. However, by configuring so that the two LEDs 21 and 22 are integrated into the single LED chip 2 as in this example embodiment, the abovementioned problems can be solved. That is to say, in this example embodiment, a shorter distance between the two LEDs suppresses uneven brightness, and the device itself can be downsized. However, the two LEDs 21 and 22 are not necessarily limited to being integrated into the single LED chip 2, and individual LEDs may be provided in the lighting circuit 1. Moreover, each of the LEDs 21 and 22 is not limited to being configured with a single LED, and each of the LEDs 21 and 22 may be configured with an LED group composed of a plurality of LEDs. For example, each of LEDs 21 and 22 may be configured with an LED group composed of a plurality of LEDs that are connected in series and light up at the same time As one example, an LED group circuit configuring the one LED 21 and an LED group circuit configuring the other LED 22 may be configured to be connected in parallel. Moreover, the two LEDs 21 and 22 are not limited to being configured with light-emitting diodes, and may be light sources that light up with any structure.

Here, as will be described later, the one LED 21 is the day-and-night LED 21 (first light source) that lights up during both the daytime and the nighttime, and the other LED 22 is the dimming LED 22 (second light source) that lights up during the daytime and goes out during the nighttime. That is to say, as will be described later, the two LEDs 21 and 22, namely, the day-and-night LED 21 and the dimming LED 22 both light up during the daytime, and only the day-and-night LED 21 lights up during the nighttime.

Further, the day-and-night LED 21 (one LED) and the dimming LED 22 (other LED) are configured to have different luminous intensities when lighting. In particular, the dimming LED 22 is configured to have a higher luminous intensity when lighting than the day-and-night LED 21. As an example, the dimming LED 22 is configured to have a luminous intensity when lighting about five times higher than the day-and-night LED 21. In this case, the ratio of luminous intensities between daytime when both the day-and-night LED 21 and the dimming LED 22 light up and nighttime when only the day-and-night LED 21 lights up is approximately 6:1. However, the difference in luminous intensity when lighting between the day-and-night LED 21 and the dimming LED 22 mentioned above is merely an example, and the LEDs may be configured so that any difference in luminous intensity is made. Moreover, the day-and-night LED 21 and the dimming LED 22 may be configured to have the same luminous intensity when lighting, or conversely, the dimming LED 22 may be configured to have a lower luminous intensity when lighting than the day-and-night LED 21. In this example embodiment, the intensity of light emitted by the LEDs 21 and 22 themselves is referred to as luminous intensity, and the brightness of the indicator light T illuminated by the LEDs 21 and 22 is referred to as luminance.

Then, as shown in FIG. 2, the day-and-night LED 21 and the dimming LED 22 are connected to parallel circuits 11 and 12 branched and connected to an electric current source 10 within the lighting circuit. That is to say, the day-and-night LED 21 is connected to one circuit 11 of the parallel circuits 11 and 12 connected to the electric current source 10, and the dimming LED 22 is connected to the other circuit 12.

Further, a dimming circuit 13 is connected to the other circuit 12 with the dimming LED 22 among the parallel circuits 11 and 12 connected, downstream from the dimming LED 22 with respect to the electric current source 10. Specifically, electronic components are connected to the other circuit 12 downstream from the electric current source 10 in order of the dimming LED 22, a diode, and a resistor, and the dimming circuit 13 is connected between the diode and the resistor. Then, a diode and a switch 14 are connected to the dimming circuit 13 upstream from a connection point with the other circuit 12, and an electric current flows from even upstream when the switch 14 is on. Therefore, in the dimming circuit 13, when the switch 14 is on and an electric current flows from upstream, the electric current flows through the connection point with the other circuit 12 and the resistor connected to the downstream side of the other circuit 12. As a result, when an electric current flows through the dimming circuit 13, no electric current flows from the electric current source 10 to the dimming LED 22 of the other circuit 12.

Then, the switch 14 of the dimming circuit 13 is controlled to be turned on and off by the control device 3. At this time, the control device 3 determines whether it is daytime or nighttime, for example, based on information that can be acquired by the vehicle, and controls the switch 14 to be turned off when determining it is daytime, and to be turned on when determining it is nighttime. As an example, the control device 3 determines that it is daytime when illuminance detected by an illuminance sensor installed in the vehicle is equal to or more than a preset reference value for determining that it is bright, and determines that it is nighttime when the illuminance is less than the reference value. As another example, the control device 3 may determine whether it is daytime or nighttime based on the lighting state of the headlights of the vehicle. For example, the control device may determine that it is daytime when the headlights are off and that it is nighttime when the headlights are on. Furthermore, as an example, the control device 3 may determine whether it is daytime or nighttime based on the current time, or may determine based on any information.

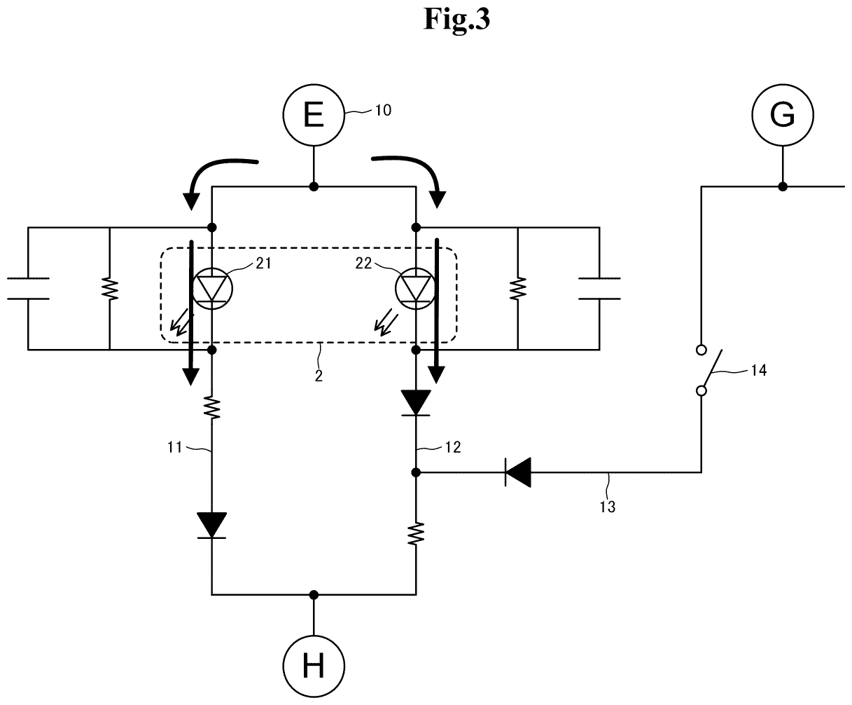

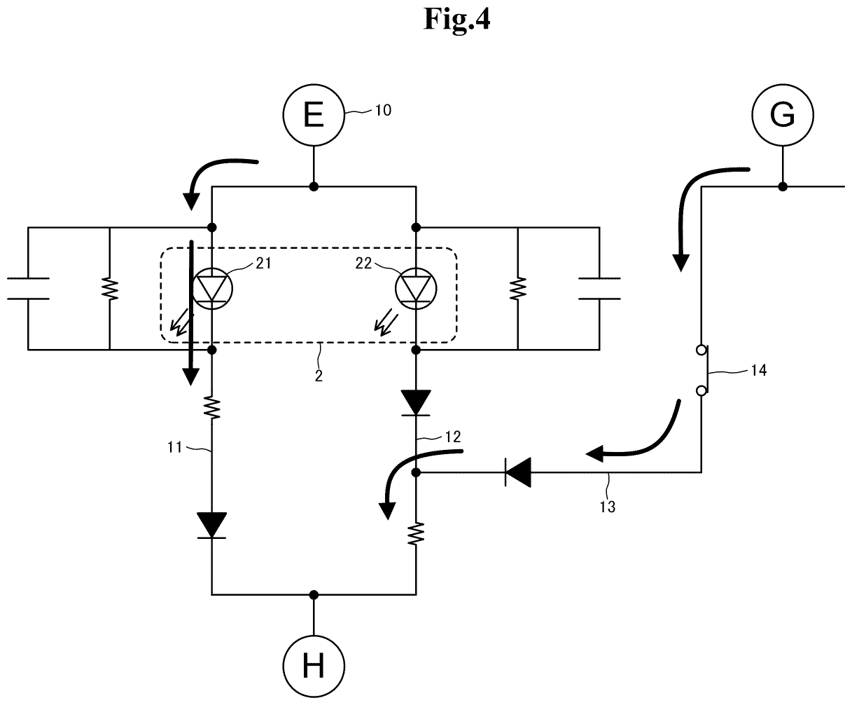

Here, the operation of the lighting circuit will be described with reference to FIGS. 3 and 4. FIG. 3 shows an aspect of the lighting circuit when the control device 3 determines that it is daytime. Since the switch 14 is off during the daytime, an electric current flows through each of the parallel circuits 11 and 12 connected to the electric current source 10 of the lighting circuit as indicated by arrows in FIG. 3. That is to say, during the daytime, an electric current flows through both the day-and-night LED 21 and the dimming LED 22, and makes them light up at the same time. Consequently, since the indicator light T is illuminated by both the day-and-night LED 21 and the dimming LED 22, the indicator light T is illuminated at a brightness higher than that during the nighttime to be described later so that the illumination of the indicator light T is easily recognized even during the daytime when the surroundings are bright.

Further, FIG. 4 shows an aspect of the lighting circuit when the control device 3 determines that it is nighttime. Since the switch 14 is on during the nighttime, an electric current flows through the dimming circuit 13 as indicated by arrows in FIG. 4. That is to say, an electric current flows from the upstream side of the dimming circuit 13 to the downstream side of the other circuit 12 of the parallel circuit 12. Then, an electric current from the electric current source 10 does not flow through the other circuit 12 connected to the dimming circuit 13 among the parallel circuits 11 and 12 connected to the electric current source 10 of the lighting circuit, and the electric current from the electric current source 10 flows through only the one circuit 11. That is to say, the electric current flows through only the day-and-night LED 21 during the nighttime, so that the day-and-night LED 21 is turned on and the dimming LED 22 is turned off. Consequently, the indicator light T is illuminated by only the day-and-night LED 21, so that the indicator light T is illuminated at a brightness lower than that during the daytime.

As described above, in this example embodiment, the two LEDs 21 and 22 that illuminate the same illuminated part such as the indicator light T are provided, the two LEDs 21 and 22 are turned on during the daytime, and only the one LED 21 is turned on during the nighttime. Consequently, it is possible to make a difference in luminance of the indicator light T between daytime and nighttime, and it is possible to increase the visibility of the indicator light T for users during both the daytime and the nighttime. At this time, by configuring the dimming LED 22 turned off during the nighttime and turned on during the daytime to have a luminous intensity higher than the day-and-night LED 21, it is possible to further make a difference in luminance of the illuminated indicator light T between daytime and nighttime, and it is possible to further increase the visibility. Furthermore, it is possible to configure with a simple circuit, for example, providing the dimming circuit 13 as described above, and it is possible to realize at low cost.

### SUPPLEMENTARY NOTES

The whole or part of the example embodiments disclosed above can be described as the following supplementary notes. Below, the overview of the configurations of a lighting circuit, a lighting device, and a lighting method according to the present disclosure will be described.

However, the present disclosure is not limited to the following configurations

### Supplementary Note 1

A lighting circuit comprising a first light source and a second light source that light up to illuminate a same illuminated part,
wherein both the first light source and the second light source are turned on in a preset first lighting situation, and the first light source is turned on and the second light source is turned off in a preset second lighting situation.

### Supplementary Note 2

The lighting circuit according to Supplementary Note 1, wherein the first light source and the second light source are integrated within a single chip.

### Supplementary Note 3

The lighting circuit according to Supplementary Note 2, wherein luminous intensities in lighting are different between the first light source and the second light source.

### Supplementary Note 4

The lighting circuit according to Supplementary Note 3,
wherein a luminous intensity in lighting of the second light source is higher than that of the first light source.

### Supplementary Note 5

The lighting circuit according to Supplementary Note 1, wherein:
in the first lighting situation, electric current flows through the first light source and the second light source; and
in the second lighting situation, electric current flows through the first light source, and electric current does not flow through the second light source due to electric current flown through a specific circuit connected to the second light source.

### Supplementary Note 6

The lighting circuit according to Supplementary Note 1,
wherein the first lighting situation is a preset situation determined to be daytime, and the second lighting situation is a preset situation determined to be nighttime.

### Supplementary Note 7

A lighting device comprising:
a lighting circuit including a first light source and a second light source that light up to illuminate a same illuminated part; and
the illuminated part,
wherein the lighting circuit is configured to turn on both the first light source and the second light source in a preset first lighting situation, and turn on the first light source and turn off the second light source in a preset second lighting situation.

### Supplementary Note 8

A lighting method by a lighting circuit including a first light source and a second light source that light up to illuminate a same illuminated part, the lighting method comprising
turning on both the first light source and the second light source in a preset first lighting situation, and turning on the first light source and turning off the second light source in a preset second lighting situation.

### DESCRIPTION OF REFERENCE NUMERALS

1 lighting circuit
11, 12 parallel circuit
13 dimming circuit
14 switch
2 LED chip
21 day-and-night LED (one LED)
22 dimming LED (other LED)
3 control device

1. A lighting circuit comprising a first light source and a second light source that light up to illuminate a same illuminated part,
wherein both the first light source and the second light source are turned on in a preset first lighting situation, and the first light source is turned on and the second light source is turned off in a preset second lighting situation.

2. The lighting circuit according to claim 1,
wherein the first light source and the second light source are integrated within a single chip.

3. The lighting circuit according to claim 2,
wherein luminous intensities in lighting are different between the first light source and the second light source.

4. The lighting circuit according to claim 3,
wherein a luminous intensity in lighting of the second light source is higher than that of the first light source.

5. The lighting circuit according to claim 1, wherein:
in the first lighting situation, electric current flows through the first light source and the second light source; and
in the second lighting situation, electric current flows through the first light source, and electric current does not flow through the second light source due to electric current flown through a specific circuit connected to the second light source.

6. The lighting circuit according to claim 1,
wherein the first lighting situation is a preset situation determined to be daytime, and the second lighting situation is a preset situation determined to be nighttime.

7. Alighting device comprising:
a lighting circuit including a first light source and a second light source that light up to illuminate a same illuminated part; and
the illuminated part,
wherein the lighting circuit is configured to turn on both the first light source and the second light source in a preset first lighting situation, and turn on the first light source and turn off the second light source in a preset second lighting situation.

8. A lighting method by a lighting circuit including a first light source and a second light source that light up to illuminate a same illuminated part, the lighting method comprising
turning on both the first light source and the second light source in a preset first lighting situation, and turning on the first light source and turning off the second light source in a preset second lighting situation.
